(19) United States
(12) Patent Application Publication
(10) Pub. No.: US 2016/0089989 A1
(43) Pub. Date: Mar. 31, 2016

(54) WIRELESS POWER TRANSMISSION DEVICE HAVING USER INTERFACE STRUCTURE AND METHOD FOR CONTROLLING THE SAME

(71) Applicant: HYUNDAI MOBIS CO., LTD., Seoul (KR)

(72) Inventor: Ha-Jeong PARK, Yongin-si (KR)

(73) Assignee: HYUNDAI MOBIS CO., LTD., Seoul (KR)

(21) Appl. No.: 14/857,158

(22) Filed: Sep. 17, 2015

(30) Foreign Application Priority Data
Sep. 30, 2014 (KR) 10-2014-0131147

(51) Int. Cl. B60L 11/18; H02J 7/00

(52) U.S. Cl. CPC B60L 11/182; B60L 11/1838; B60L 11/1861; H02J 7/0047

(57) ABSTRACT

A wireless power transmission device may include a power transmitter configured to transmit power for charging, a power receiver configured to perform a communication protocol with the power transmitter and receive the power transmitted from the power transmitter, and an interface configured to exchange information for performing the charging based on the power receiver and the communication protocol and control power transmission from the power transmitter to the power receiver depending on the exchange of the information.

### CROSS-REFERENCE(S) TO RELATED APPLICATIONS

This application claims priority to Korean Patent Application No(s). 10-2014-0131147 filed on Sep. 30, 2014 in the Korean Intellectual Property Office, which is incorporated herein by reference in its (their) entirety.

### BACKGROUND OF THE INVENTION

1. Field of the Invention

Exemplary aspects of the present invention relate to a wireless power transmission device, and more particularly, to a wireless power transmission device and a method for controlling the same capable of quickly figuring out a state of charge by the wireless power transmission device at an outside of a vehicle and abnormal situations during charging, by providing an interface between a power receiving module of the wireless power transmission device and a user outside the vehicle and performing data communication between the power receiving module and the interface depending on communication protocols of the present invention.

2. Description of Related Art

A technology of wirelessly charging the vehicle using a current high voltage battery defines only the communication protocol among a wireless power transmission device, a power transmitting module, and a power receiving module as well as a communication protocol between a power receiving module and a Battery Management System (BMS). That is, there is no description of the interface connection between the wireless power transmission device and the user and the communication protocol defining the wireless data communication between the wireless power transmission device and the interface.

In particular, when the vehicle battery is wirelessly charged using the wireless power transmission, a charging time of 8 hours is required based on 3.3 kW and the charging time of four hours is required based on 6.6 kW. Therefore, the user may not figure out the progress of wireless charging for the charging time and thus needs to frequently confirm a charging display device, etc., which is equipped in the vehicle.

Further, when the charging problem at the time of wirelessly charging the vehicle occurs, the problem situations may not be figured out and thus the handling of the problem situations may be delayed or may not be made, such that the wireless charging device of the vehicle is abnormally operated to do a great deal of damage to the vehicle.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present invention is directed to a wireless power transmission device and a method for controlling the same capable of allowing a user at an outside of the vehicle to quickly figure out a state of charge of a battery of a vehicle and abnormal situations during charging to control whether to charge the vehicle is charged, by coupling the wireless power transmission device with an interface controlling the wireless power transmission device at the outside of the vehicle and defining communication protocols operating the wireless power transmission device and the interface.

Other objects and advantages of the present invention can be understood by the following description, and become apparent with reference to the aspects of the present invention. Also, it is obvious to those skilled in the art to which the present invention pertains that the objects and advantages of the present invention can be realized by the means as claimed and combinations thereof.

In accordance with an aspect of the present invention, a wireless power transmission device includes a power transmitter configured to transmit power for charging, a power receiver configured to perform a communication protocol with the power transmitter and receive the power transmitted from the power transmitter, and an interface configured to exchange information for performing the charging based on the power receiver and the communication protocol and control power transmission from the power transmitter to the power receiver depending on the exchange of the information.

The information transmitted from the interface to the power receiver may include at least one of terminal state information, charging start and finish information, charging time setting information, charging power setting information, and position correction start information and position correction finish information of a matching assistant.

The interface may be a communication terminal wirelessly communicating with the power receiver.

The interface may display a wireless power transmission progress of a vehicle, display a charging quantity, display charging remained time, or display no charging situation.

The interface may receive at least one of charging start, charging stop, charging finish, charging power, and charging time.

The interface may provide a charging related screen mode.

In accordance with another aspect of the present invention, a method for controlling a wireless power transmission device includes exchanging, by an interface, information for performing charging based on a power receiver and a communication protocol, performing the communication protocol between a power transmitter and the power receiver depending on the exchange of the information, transmitting, by the power transmitter, power depending on the communication protocol between the power transmitter and the power receiver; and receiving, by the power receiver, the power from the power transmitter by a control of the interface.

Other features and aspects will be apparent from the following detailed description, the drawings, and the claims.

### BRIEF DESCRIPTION OF THE DRAWINGS

FIG. 1 is a block diagram illustrating a wireless power transmission device according to the related art.

FIG. 2 is a block diagram illustrating data transmission and reception among a power transmitting module, a power receiving module, and a Battery Management System (BMS) according to the related art.

FIG. 3 is a block diagram illustrating a user interface of a wireless power transmission device according to an exemplary aspect of the present invention.

FIG. 4 is a block diagram illustrating a mode screen of a user interface of the wireless power transmission device according to the exemplary aspect of the present invention.

FIG. 5 is a block diagram illustrating data transmission and reception between the power receiving module and a user interface module in the user interface of the wireless power transmission device according to the exemplary aspect of the present invention.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that may be well known to one of ordinary skill in the art may be omitted for increased clarity and conciseness.

It is to be noted that technical terms used in the specification are used for describing specific aspects and do not limit the present invention. In addition, unless indicated otherwise in the specification, it is to be understood that all the technical terms used in the specification are construed as meaning as those that are generally understood by those who skilled in the art and as excessively comprehensive meanings and excessively reduced meanings. Further, the accompanying drawings are provided to easily understand the technical spirit of the present invention disclosed in the present specification, and therefore the technical spirit is not limited to the accompany drawings. Therefore, it is to be construed that the accompanying drawings include all modifications and replacements included in the technical spirit and the technical scope disclosed in the present specification.

Hereinafter, a wireless power transmission device according to an exemplary aspect of the present invention will be described in more detail with reference to the accompanying drawings.

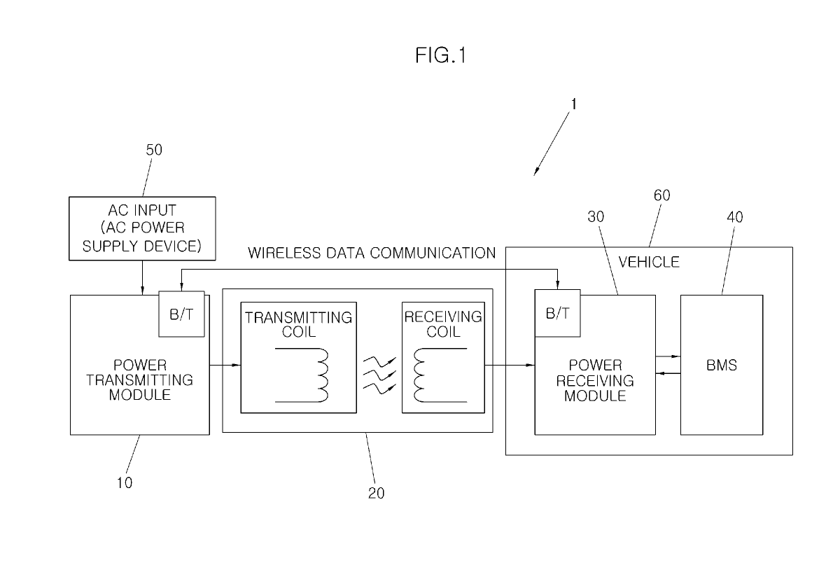

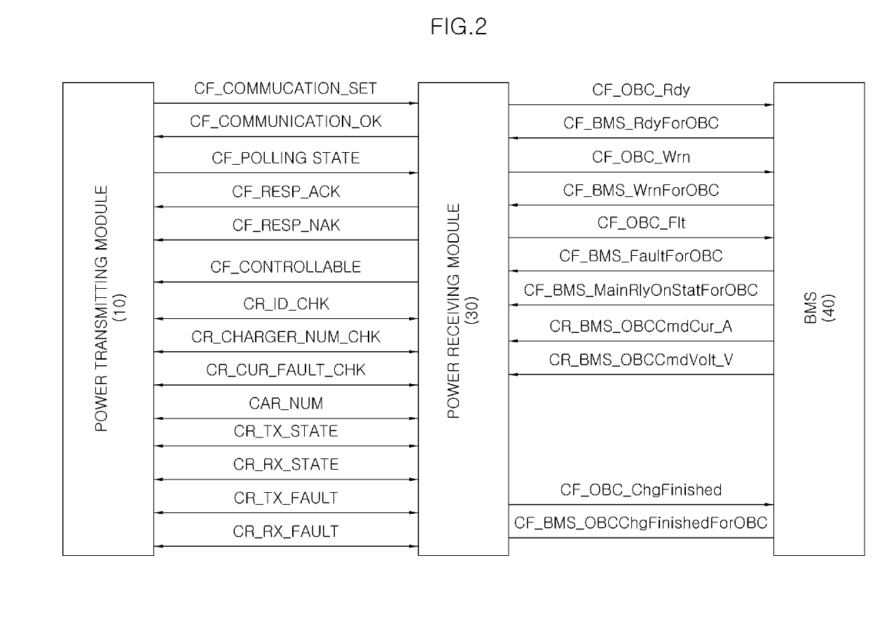

FIG. 1 is a block diagram illustrating a wireless power transmission device according to the related art and FIG. 2 is a block diagram illustrating data transmission and reception among a power transmitting module, a power receiving module, and a Battery Management System (BMS) according to the related art.

Referring to FIG. 1 and FIG. 2, a wireless power transmission device 1 for a vehicle is configured to include a power transmitting module 10 supplied with AC 220V in a lagged state to switch a transmitting coil, a transmitting/receiving pickup coil 20 for transferring energy of the power transmitting module to a power receiving module by resonance, a power receiving module 30 for switching the power received energy to meet a high voltage battery, a BMS 40, and a power supply device 50 for supplying power to the power transmitting module.

The power transmitting module 10 may be installed on a road or a bottom in a parking lot, the power receiving module 30, installed at a lower portion of a vehicle 60, etc., may perform wireless data communication depending on a communication protocol, thereby performing wireless charging starting, wireless charging, and wireless charging finish operations, etc.

In more detail, in the wireless data communication between the power transmitting module 10 and the power receiving module 30, information that is provided to the power receiving module 30 by the power transmitting module 10 may depend on communication protocols shown in the following Tables 1 to 4.

TABLE 1

| | | | | | | STATE | | | |
|---|---|---|---|---|---|---|---|---|---|
| | | | | DATA | | VALUE | | | |
| ID | DATA | PERIOD | | BYTE | BIT | (Example) | FROM | TO | Contents |
| XX1 | CF_COMMUNICATION_SET | 100 | ms | 0 | 0 | 1 | Power | Power | Set |
| | | | | | | | Transmitting | Receiving | Communication |
| | | | | | | | Module | Module | state (start |
| | | | | | | | | | communication) |
| | CF_POLLING STATE | | | | 1 | 1 | | | Message for |
| | | | | | | | | | periodically |
| | | | | | | | | | monitoring power |
| | | | | | | | | | receiving module |
| | | | | | | | | | state |
| | CR_ID_CHK | | | 2 | 16 | ABCDE | | | ID confirmation |
| | | | | | | | | | message |
| | CR_CHARGER_NUM_CHK | | | 4 | 32 | 1234 | | | Charger number |
| | | | | | | | | | confirmation |
| | | | | | | | | | message |
| | CR_CUR_FAULT_CHK | | | 6 | 48 | 1011 | | | Current fault |
| | | | | | | | | | information |
| | | | | | | | | | confirmation |
| | | | | | | | | | message |
| | CAR_NUM | 1 | s | 7 | 56 | 0~255 | | | Vehicle |

identification
number

In the above Table 1, XX1 is information which the power transmitting module 10 transmits and is data about the communication state and the power receiving module confirmation message between the power transmitting module and the power receiving module, vehicle information, etc.

TABLE 2

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX2 | CF_CONTROL_START | 100 ms | 0 | 0 | 1 | Power | Power | Start wireless |
| | | | | | | Transmitting | Receiving | charging |
| | CR_TX_STATE | | 1 | 8 | 0~4 | Module | Module | 0: Normal, 1: |
| | | | | | | | | Abnormal, 2: |
| | | | | | | | | Standby, 3: Power |
| | | | | | | | | transmission, 4: |
| | | | | | | | | Transmit power |
| | | | | | | | | transmitting |
| | | | | | | | | module state |
| | | | | | | | | value |
| | CR_RX_STATE | | 2 | 16 | 0~4 | | | 0: Normal, 1: |
| | | | | | | | | Abnormal, 2: |
| | | | | | | | | Standby, 3: Power |
| | | | | | | | | transmission, 4: |
| | | | | | | | | Request power |
| | | | | | | | | transmitting |
| | | | | | | | | module state |
| | | | | | | | | value |
| | CR_TX_FAULT | | 4 | 32 | 1111 | | | Power |
| | | | | | | | | transmitting |
| | | | | | | | | module fault state |
| | | | | | | | | message |
| | CR_RX_FAULT | | 6 | 48 | 1011 | | | Power receiving |
| | | | | | | | | module fault state |
| | | | | | | | | message |

In the above Table 2, XX2 is information which the power transmitting module 10 transmits and is data about state of charge information, etc.

TABLE 3

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX3 | BMS_INFO_REQ | 100 ms | 0 | 0 | 1 | Power | Power | Request BMS |
| | | | | | | Transmitting | Receiving | information |
| | BMS_INFO_RESP_ACK | | 1 | 8 | 1 | Module | Module | BMS information |
| | | | | | | | | normal response |
| | | | | | | | | message |
| | BMS_INFOR_RESP_NAK | | | 9 | 1 | | | BMS information |
| | | | | | | | | abnormal |
| | | | | | | | | response |
| | | | | | | | | message |
| | RX_CHAR_INFO_REQ | | 2 | 16 | 1 | | | Request power |
| | | | | | | | | receiving module |
| | | | | | | | | information |
| | RX_CHAR_INFO_RESP_ACK | | 3 | 24 | 1 | | | Power receiving |
| | | | | | | | | module |
| | | | | | | | | information |
| | | | | | | | | normal response |
| | | | | | | | | message |
| | RX_CAR_INFO_RESP_NAK | | | 25 | 1 | | | Power receiving |
| | | | | | | | | module |
| | | | | | | | | information |
| | | | | | | | | abnormal |
| | | | | | | | | response |
| | | | | | | | | message |

In the above Table 3, XX3 is information which the power transmitting module 10 transmits and is data about the BMS and power receiving module related information request, etc.

TABLE 4

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX4 | CR_TX_AC_VOL | 100 ms | 0 | 0 | 0~500 | Power | Power | Power |
| | | | | | | Transmitting | Receiving | transmitting |
| | | | | | | Module | Module | module input |
| | | | | | | | | voltage |
| | CR_TX_AC_CUR | | 1 | 8 | 0~50 | | | Power |
| | | | | | | | | transmitting |
| | | | | | | | | module input |
| | | | | | | | | current |
| | CR_TX_PSFB_IN_CUR | | 2 | 16 | 0~50 | | | Power |
| | | | | | | | | transmitting |
| | | | | | | | | module full |
| | | | | | | | | bridge input |
| | | | | | | | | voltage |
| | CR_TX_PSFB_IN_VOL | | 3 | 14 | 0~500 | | | Power |
| | | | | | | | | transmitting |
| | | | | | | | | module full |
| | | | | | | | | bridge input |
| | | | | | | | | current |
| | CR_TX_TEMP | | 5 | 40 | −40~150 | | | Power |
| | | | | | | | | transmitting |
| | | | | | | | | module |
| | | | | | | | | temperature |

In the above Table 4, XX4 is information which the power transmitting module 10 transmits and is data about the power transmitting module information, etc.

Further, in the wireless data communication between the power transmitting module 10 and the power receiving module 30, information which is provided to the power transmitting module 10 by the power receiving module 30 depends on communication protocols shown in the following Tables 5 to 8.

TABLE 5

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX5 | CF_CONTROLLABLE | 100 ms | 0 | 0 | 1 | Power | Power | Wireless |
| | | | | | | Receiving | Transmitting | charging start |
| | | | | | | Module | Module | possible state |
| | | | | | | | | information |
| | | | | | | | | message |
| | CF_COMMUNICATION_OK | | | 1 | 1 | | | Communication |
| | | | | | | | | state |
| | | | | | | | | normality |
| | CF_RESP_ACK | | | 2 | 1 | | | Normal |
| | | | | | | | | response |
| | | | | | | | | message |
| | CF_RESP_NAK | | | 3 | 1 | | | Abnormal |
| | | | | | | | | response |
| | | | | | | | | message |
| | CR_TX_STATE | | 1 | 8 | 0~4 | | | 0: Normal, 1: |
| | | | | | | | | Abnormal, 2: |
| | | | | | | | | Standby, 3: |
| | | | | | | | | Power |
| | | | | | | | | transmission, |
| | | | | | | | | 4: Transmit |
| | | | | | | | | power |
| | | | | | | | | receiving |
| | | | | | | | | module state |
| | | | | | | | | value |
| | CR_RX_STATE | | 2 | 16 | 0~4 | | | 0: Normal, 1: |
| | | | | | | | | Abnormal, 2: |
| | | | | | | | | Standby, 3: |
| | | | | | | | | Power |
| | | | | | | | | transmission, |
| | | | | | | | | 4: Transmit |
| | | | | | | | | power |
| | | | | | | | | receiving |
| | | | | | | | | module state |
| | | | | | | | | value |
| | CR_TX_STATE | | 4 | 32 | 1111 | | | Power |
| | | | | | | | | transmitting |
| | | | | | | | | module fault |
| | | | | | | | | state message |
| | CR_RX_STATE | | 5 | 48 | 1011 | | | Power |
| | | | | | | | | receiving |
| | | | | | | | | module fault |
| | | | | | | | | state message |

In the above Table 5, XX5 is information which the power receiving module 30 transmits and is data about the communication state between the power transmitting module and the power receiving module, etc.

TABLE 6

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX6 | BMS_CUR_INFOR | 100 ms | 0 | 8 | 0~20 | Power | Power | BMS control |
| | | | | | | Receiving | Transmitting | current message |
| | BMS_VOL_INFO | | 2 | 16 | 0~500 | Module | Module | BMS control |
| | | | | | | | | voltage |
| | | | | | | | | message |
| | BMS_FAULT_STATE | | 4 | 32 | 1011 | | | BMS fault |
| | | | | | | | | information |
| | | | | | | | | message |
| | BMS_TEMP | | 6 | 48 | −40~150 | | | BMS |
| | | | | | | | | temperature |
| | | | | | | | | message |

In the above Table 6, XX6 is information which the power receiving module 30 transmits and is data about the BMS information, etc.

TABLE 7

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX7 | CR_RX_DC_VOL | 100 ms | 1 | 8 | 0~500 | Power | Power | Power receiving |
| | | | | | | Receiving | Transmitting | module output |
| | | | | | | Module | Module | voltage |
| | | | | | | | | message |
| | CR_RX_DC_CUR | | 2 | 16 | 0~50 | | | Power receiving |
| | | | | | | | | module output |
| | | | | | | | | current message |
| | CR_RX_TEMP | | 4 | 32 | −40~150 | | | Power receiving |
| | | | | | | | | module |
| | | | | | | | | temperature |
| | | | | | | | | message |

In the above Table 7, XX7 is information which the power receiving module 30 transmits and is data about the power receiving module related information, etc.

TABLE 8

| | | | | | | STATE | | | |
|---|---|---|---|---|---|---|---|---|---|
| | | | | DATA | | VALUE | | | |
| ID | DATA | PERIOD | | BYTE | BIT | (Example) | FROM | TO | Contents |
| XX8 | CR_ID_CHK | 100 | ms | 2 | 16 | ABCDE | Power | Power | ID confirmation |
| | | | | | | | Receiving | Transmitting | message |
| | CR_CHARGER_NUM_CHK | | | 4 | 32 | 1234 | Module | Module | Charger number |
| | | | | | | | | | confirmation |
| | | | | | | | | | message |
| | CR_CUR_FAULT_CHK | | | 6 | 48 | 1011 | | | Current fault |
| | | | | | | | | | information |
| | | | | | | | | | confirmation |
| | | | | | | | | | message |
| | CAR_NUM | 1 | s | 7 | 56 | 0~255 | | | Vehicle |

identification
number

In the above Table 8, XX8 is information which the power receiving module 30 transmits and is data about the vehicle information, the ID confirmation, etc.

The power receiving module 30 and the BMS 40 which are mounted at the lower portion of the vehicle may perform an exchange of related information such as a charging state, a voltage, a current, and a command value and may stably perform the charging operation.

In more detail, in the data communication between the power receiving module 30 and the BMS 40, the information provided between the power receiving module 30 and the BMS 40 may depend on communication protocols of the following Table 9 and 10.

TABLE 9

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XX9 | CF_OBC_Rdy | 100 ms | 0 | 0 | 1 | Power | BMS | Ready (CAN |
| | | | | | | Transmitting | | communication |
| | | | | | | Module | | inside |
| | | | | | | | | charger, |
| | | | | | | | | control board |
| | | | | | | | | ready |
| | | | | | | | | command) |
| | CF_OBC_Wrn | | | 1 | 1 | | | Set at the time |
| | | | | | | | | of occurrence |
| | | | | | | | | of fault |
| | | | | | | | | situation other |
| | | | | | | | | than OBC fault |
| | CF_OBC_Flt | | | 2 | 1 | | | Fault (set at |
| | | | | | | | | the time of |
| | | | | | | | | occurrence of |
| | | | | | | | | OBC fault |
| | | | | | | | | situation) |
| | CF_OBC_CharMode | | | 3 | 3 | | | Charging |
| | | | | | | | | mode |
| | | | | 4 | | | | (CC/CV/CP) |
| | CF_OBC_Connection | | | 5 | 1 | | | Charging |
| | | | | | | | | connector |
| | | | | | | | | fastening state |
| | CF_OBC_ChgFinished | | | 6 | 1 | | | Charging finish |
| | | | | | | | | (value: 1 |
| | | | | | | | | finish) |
| | CF_OBC_PowerEnaStat | | | 7 | 1 | | | Inform |
| | | | | | | | | charging |
| | | | | | | | | possible ready |
| | | | | | | | | state |
| | CF_OBC_FltCode | | 1 | 8 | 0~255 | | | Charger error |
| | | | | | | | | code |
| | | | | | | | | (diagnosis |
| | | | | | | | | communication |
| | | | | | | | | code) |
| | CR_OBC_Temp | | 2 | 16 | 40~120° C. | | | Internal |
| | | | | | | | | temperature of |
| | | | | | | | | charger |
| | CR_OBC_Effi | | 3 | 24 | 0~110% | | | Charger |
| | | | | | | | | efficiency |
| | CR_OBC_MaxPwr_W | | 4 | 32 | Based on | | | Maximum |
| | | | | | 50 W | | | chargeable |
| | | | | | | | | power value |
| | CR_OBC_MaxCur_A | | 5 | 40 | 0~150 W | | | Maximum |
| | | | | | | | | chargeable |
| | | | | | | | | current value |
| | CR_OBC_MaxVolt_V | | 6 | 48 | 0~1100 W | | | Maximum |
| | | | 7 | 56 | | | | chargeable |
| | | | | | | | | voltage value |

In the above Table 9, XX9 is information which the power receiving module 30 transmits and is data about internal state information of the power receiving module, charging related state information, etc.

TABLE 10

| | | | | | STATE | | | | |
|---|---|---|---|---|---|---|---|---|---|
| | | | DATA | | VALUE | | | | |
| ID | DATA | PERIOD | BYTE | BIT | (Example) | | FROM | TO | Contents |
| XXA | CF_BMS_RdyForOBC | 100 ms | 0 | 0 | 1 | | BMS | Power | Ready (CAN |
| | | | | | | | | Receiving | communication |
| | | | | | | | | Module | inside |
| | | | | | | | | | vehicle, ready |
| | | | | | | | | | command) |
| | CF_BMS_WrnForOBC | | | 1 | 1 | | | | Warning (set |
| | | | | | | | | | at the time of |
| | | | | | | | | | occurrence of |
| | | | | | | | | | fault situation |
| | | | | | | | | | other than |
| | | | | | | | | | BMC fault) |
| | CF_BMS_FaultForOBC | | | 2 | 1 | | | | Fault (set at |
| | | | | | | | | | the time of |
| | | | | | | | | | occurrence of |
| | | | | | | | | | fault situation |
| | | | | | | | | | which |
| | | | | | | | | | corresponds to |
| | | | | | | | | | no charging) |
| | CF_BMS_MainRlyOnStatForOBC | | | 3 | 1 | | | | High voltage |
| | | | | | | | | | relay on/off |
| | | | | | | | | | state at the |
| | | | | | | | | | time of |
| | | | | | | | | | charging |
| | CF_BMS_PwrLmtForOBC | | | 4 | 3 | | | | Limit charging |
| | | | | 5 | | | | | power |
| | CF_BMS_AbnorChg | | | 6 | 1 | | | | State of |
| | | | | | | | | | charge (0: |
| | | | | | | | | | Normal, 1: |
| | | | | | | | | | Abnormal) |
| | CF_BMS_OBCChgFinishedForOBC | | | 7 | 1 | | | | Charging finish |
| | | | | | | | | | state |
| | CF_BMS_SoForOBC_Pc | | 1 | 8 | 5-90% | | | | Battery SOC |
| | | | | | | | | | (%) |
| | CR_BMS_CharRemainedTime_min | | 2 | 16 | 0~600 | min | | | Charging |
| | | | 3 | 24 | | | | | remained time |
| | | | | | | | | | (remained time |
| | | | | | | | | | against full |
| | | | | | | | | | charging) |
| | CR_BMS_OBCcmdCur_A | | 4 | 32 | 0~150 | A | | | CC mode |
| | | | 5 | 40 | | | | | constant |
| | | | | | | | | | current value |
| | CR_BMS_OBCCmdVolt_V | | 6 | 48 | 0~1100 | W | | | CV mode |

| | | |
|---|---|---|
| 7 | 56 | constant |
| | | voltage value |

In the above Table 10, XXA is information which the BMS 40 transmits and is data about internal state information of the BMS, charging related state information, etc.

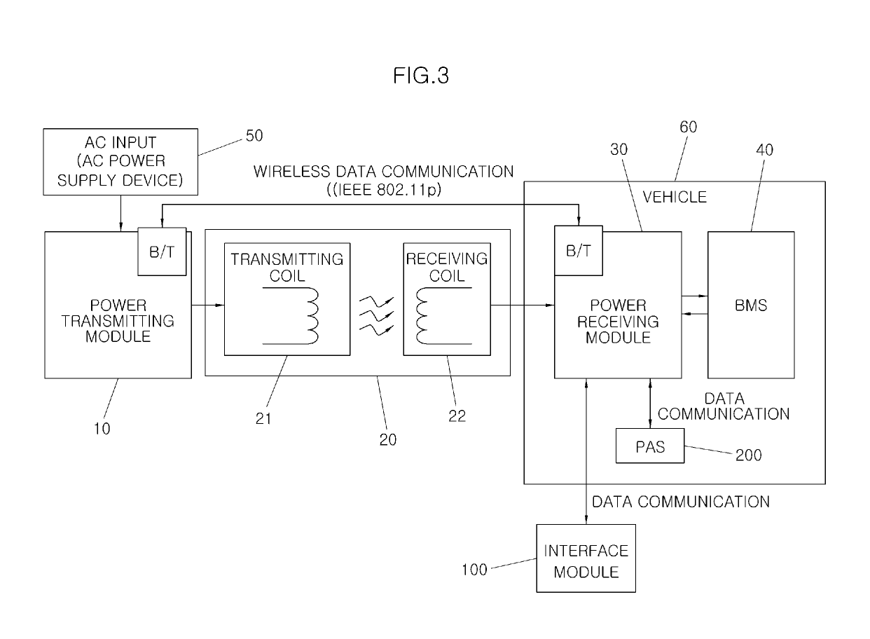

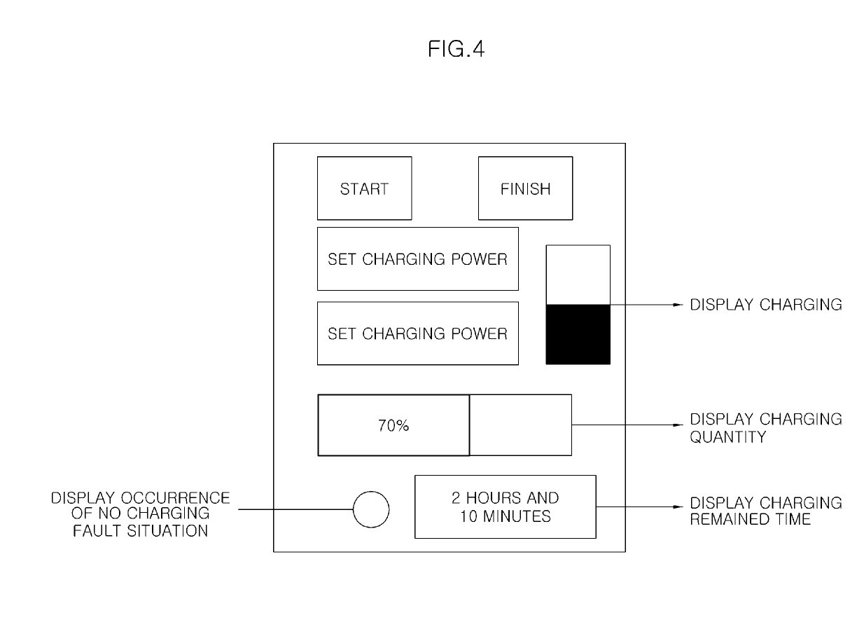

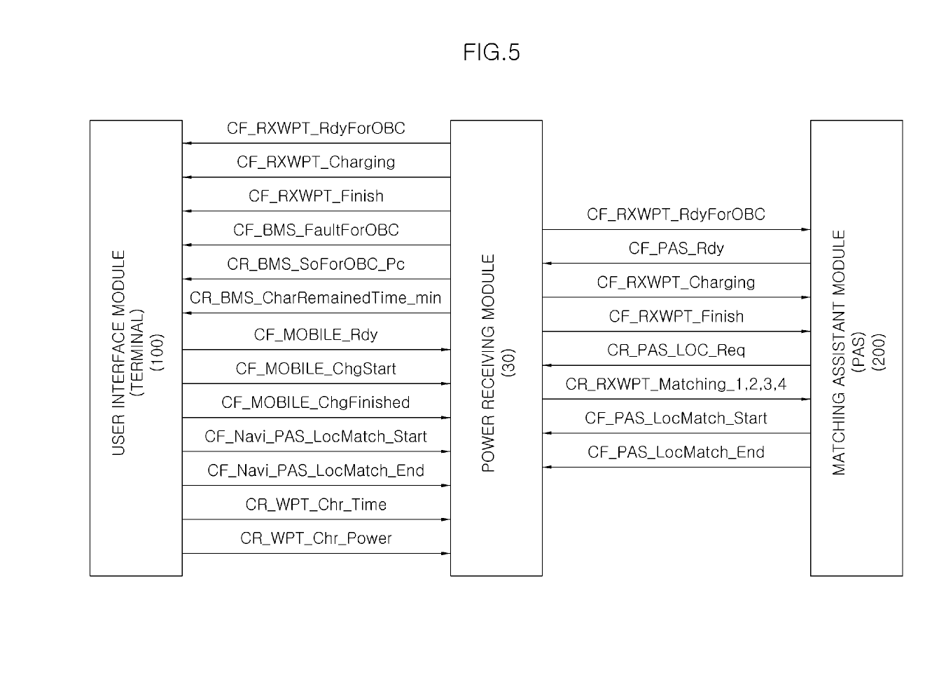

Referring to FIGS. 3 to 5, the user interface of a wireless power transmission device according to the exemplary aspect of the present invention may include a power transmission module 10, a power receiving module 30, a user interface module 100, and a matching assistant module 200.

The power transmitting module 10 may be installed outside a vehicle 60 and is configured to transmit power.

The power receiving module 30 may be installed in the vehicle 60 and receives power from the power transmitting module 10.

The user interface module 100 controls power transmission from the power transmitting module 10 to the power receiving module 30 at the outside of the vehicle 60. That is, the user interface module 100 is an interface device which may control the power transmission from the power transmitting module 10 to the power receiving module 30 at the outside of the vehicle 60.

Further, the user interface module 100 may display wireless power transmission progress situation of the vehicle, display a charging quantity, display charging remained time, or display no charging situation. Further, the user interface module 100 may receive charging start, charging stop, charging finish, charging power, or charging time.

Here, the user interface module 100 may be a communication terminal which performs data communication with the power receiving module 30 and may be, for example, a mobile phone or a tablet PC. Therefore, a charging related screen mode is provided. In this screen mode, a charging start button, a charging finish button, a charging setting button, a charging quantity display window, etc., may be configured.

In more detail, the user interface module 100 may control the power receiving module 30 to perform data communication so as to charge a battery of the vehicle 60. In this case, the user interface module 100 may receive power receiving module state information, charging related progress information, fault occurrence situation information, charging quantity display information, and charging remained time information from the power receiving module 30. Further, the user interface module 100 may transmit terminal state information, charging start and finish information, charging time setting information, charging power setting information, and position correction start information and position correction finish information of the matching assistant module to the power receiving module 30.

In particular, the user interface module 100 may perform the data communication with the power receiving module 30 depending on the communication protocols as shown in the following Tables 11 and 12.

TABLE 11

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XXB | CF_RXWPT_RdyForOBC | 100 ms | 0 | 0 | 1 | Power | User | Power receiving |
| | | | | | | Receiving | Interface | module Ready |
| | | | | | | Module | Module | state (CAN |
| | | | | | | | (Terminal) | communication |
| | | | | | | | | in charger, |
| | | | | | | | | prepare control |
| | | | | | | | | board) |
| | CF_RXWPT_Charging | | | 1 | 1 | | | Display |
| | | | | | | | | charging |
| | CF_RXWPT_Finish | | | 2 | 1 | | | Display |
| | | | | | | | | charging finish |
| | CF_BMS_FaultForOBC | | | 3 | 1 | | | Fault (set at the |
| | | | | | | | | time of |
| | | | | | | | | occurrence of |
| | | | | | | | | fault situation |
| | | | | | | | | which |
| | | | | | | | | corresponds to |
| | | | | | | | | no charging) |
| | CF_BMS_SoForOBC_Pc | | 1 | 8 | 5~90% | | | Display |
| | | | | | | | | charging |
| | | | | | | | | quantity |
| | CF_BMS_CharRemainedTime_min | | 2 | 16 | 0~600 min | | | Charging |
| | | | 3 | 24 | | | | remained time |
| | | | | | | | | (remained time |
| | | | | | | | | against full |
| | | | | | | | | charging) |

In the above Table 11, XXB is information transmitted to the user interface module 100 by the power receiving module 30 and is data about the state information of the power receiving module, the charging related state information, etc.

TABLE 12

| | | | | | STATE | | | | |
|---|---|---|---|---|---|---|---|---|---|
| | | | DATA | | VALUE | | | | |
| ID | DATA | PERIOD | BYTE | BIT | (Example) | | FROM | TO | Contents |
| XXC | CF_MOBILE_Rdy | 100 ms | 0 | 0 | 1 | | User | Power | Communication |
| | | | | | | | Interface | Receiving | terminal Ready |
| | | | | | | | Module | Module | state |
| | CF_MOBILE_ChgStart | | | 1 | 1 | | (Terminal) | | Charging start |
| | | | | | | | | | button |
| | CF_MOBILE_ChgFinished | | | 2 | 1 | | | | Charging finish |
| | | | | | | | | | button |
| | CF_Navi_PAS_LocMatch_Start | | | 3 | 1 | | | | Start PAS |
| | | | | | | | | | position |
| | | | | | | | | | correction |
| | CF_Navi_PAS_LocMatch_End | | | 4 | 1 | | | | Finish PAS |
| | | | | | | | | | position |
| | | | | | | | | | correction |
| | CR_WPT_Chr_Time | | 1 | 8 | 0~600 | min | | | Set charging |
| | | | 2 | 16 | | | | | time |
| | CR_WPT_Chr_Power | | 3 | 24 | 0~10 | kW | | | Set charging |

| | | |
|---|---|---|
| 4 | 32 | power |

In the above Table 12, XXC is information transmitted to the power receiving module 30 by the user interface module 100 and is data about terminal state information of the user interface module, charging start and finish command, position correction start and finish command of the matching assistant module, charging time, charging power setting information, etc.

The matching assistant module 200 uses position information of a transmitting coil which is connected to the power transmitting module to transmit power and position information of a receiving coil which is connected to the power receiving module to receive power to move the vehicle 60, thereby matching the transmitting coil 21 with the receiving coil 22.

That is, the matching assistant module 200 moves the vehicle 60 in which the receiving coil 22 is installed to charge a high voltage battery, and the like of the vehicle 60, thereby matching the receiving coil 22 with the transmitting coil 21 which is installed outside the vehicle.

In this case, to efficiently charge the vehicle 60 in which the high voltage battery, etc., is installed, the transmitting coil 21 needs to be accurately matched with the receiving coil 22. The reason is that the transmitting coil 21 occupies a predetermined area on a ground and thus the vehicle 60 appropriately moves to accurately match the receiving coil 22 installed in the vehicle with the transmitting coil 21 on the ground so as to increase the power transmission efficiency of the wireless power transmission device 1.

Further, the matching assistant module 200 may automatically move the vehicle 60 to match the position of the transmitting coil 21 with the position of the receiving coil 22. Here, the matching assistant module 200 may be an apparatus which may perform the data communication with the power receiving module 30 while controlling the movement of the vehicle 60 and, in particular, may be a Parking Assistant System (PAS).

In more detail, the matching assist module 200 may receive the state information of the power receiving module, charging progress state information, vehicle position information, vehicle moving coordinate information, or vehicle moving check-in information (moving finish, re-movement, etc.), etc., from the power receiving module 30. Further, the matching assistant module 200 may transmit a command/response, etc., such as the state information of the matching assistant module, the charging progress state information, moving coordinate information request state information, and vehicle moving progress state information to the power receiving module 30.

In particular, the matching assistant module 200 may perform the data communication with the power receiving module 30 depending on the communication protocols as shown in the following Tables 13 and 14.

TABLE 13

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XXD | CF_RXWPT_RdyForOBC | 100 ms | 0 | 0 | 1 | Power | PAS | Power receiving |
| | | | | | | Receiving | | module Ready |
| | | | | | | Module | | state (CAN |
| | | | | | | | | communication |
| | | | | | | | | in charger, |
| | | | | | | | | prepare control |
| | | | | | | | | board) |
| | CF_RXWPT_Charging | | | 1 | 1 | | | Display |
| | | | | | | | | charging |
| | CF_RXWPT_Finish | | | 2 | 1 | | | Display |
| | | | | | | | | charging finish |
| | CR_RXWPT_Matching_1 | | 1 | 8 | 0~50 cm | | | Correct vehicle |
| | | | | | | | | position |
| | | | | | | | | coordinate |
| | | | | | | | | (front) |
| | CR_RXWPT_Matching_2 | | 2 | 16 | 0~50 cm | | | Correct vehicle |
| | | | | | | | | position |
| | | | | | | | | coordinate |
| | | | | | | | | (back) |
| | CR_RXWPT_Matching_3 | | 3 | 24 | 0~50 cm | | | Correct vehicle |
| | | | | | | | | position |
| | | | | | | | | coordinate (left) |
| | CR_RXWPT_Matching_4 | | 4 | 32 | 0~50 cm | | | Correct vehicle |
| | | | | | | | | position |
| | | | | | | | | coordinate |
| | | | | | | | | (right) |
| | CR_Matching_info | | 5 | 40 | 3 | | | Vehicle |
| | | | | | | | | movement |
| | | | | | | | | ok/nok/re- |
| | | | | | | | | movement |

In the above Table 13, XXD is information which the power receiving module 30 transmits and is data about the state information of the power receiving module, the charging progress state information, the moving coordinate information of the vehicle position, check information (moving finish, re-movement, etc.), etc.

TABLE 14

| | | | | | STATE | | | |
|---|---|---|---|---|---|---|---|---|
| | | | DATA | | VALUE | | | |
| ID | DATA | PERIOD | BYTE | BIT | (Example) | FROM | TO | Contents |
| XXE | CF_PAS_Rdy | 100 ms | 0 | 0 | 1 | PAS | Power | PAS Ready |
| | | | | | | | Receiving | state |
| | | | | | | | Module | information |
| | CF_PAS_ChgStart | | | 1 | 1 | | | Charging start |
| | | | | | | | | information |
| | CF_PAS_ChgFinished | | | 2 | 1 | | | Charging finish |
| | | | | | | | | information |
| | CR_PAS_LOC_Req | | | 3 | 1 | | | Request moving |
| | | | | | | | | coordinate |
| | | | | | | | | information |
| | CF_PAS_LocMatch_Start | | | 4 | 1 | | | Start vehicle |
| | | | | | | | | movement |
| | CF_PAS_LocMatch_End | | | 5 | 1 | | | Stop vehicle |
| | | | | | | | | movement |

In the above Table 14, XXE is information which the matching assistant module 200 transmits and is data about the state information of the matching assistant module, the charging progress state information, the vehicle moving coordinate information request, the vehicle moving progress state information, etc.

Among the communication protocols according to the exemplary aspect of the present invention, the data which are provided to the power receiving module 30 by the power transmitting module 10 depend on the above Tables 1 to 4, similar to the existing communication protocol. Further, among the communication protocols according to the exemplary aspect of the present invention, the data which are provided to the power transmitting module by the power receiving module 30 depend on the above Tables 5 to 8, similar to the existing communication protocol. Further, among the communication protocols according to the exemplary aspect of the present invention, the data provided between the power receiving module 30 and the BMS 40 depend on the above Tables 9 to 10, similar to the contents of the existing communication protocol.

According to the wireless power transmission device in accordance with the exemplary aspects of the present invention, the user at the outside of the vehicle may quickly figure out the state of charge of the battery of the vehicle and the abnormal situations during the charging, thereby easily controlling whether to charge the vehicle.

As described above, the exemplary aspect of the present invention may be changed by those skilled in the art within the scope of the basic technical idea of the present invention and the scope of the present invention should be analyzed based on the appended claims.

The apparatuses, units, modules, devices, and other components illustrated in FIGS. 1-5, for example, that may perform operations described herein with respect to FIGS. 1-5, for example, are implemented by hardware components. Examples of hardware components include controllers, sensors, memory, drivers, and any other electronic components known to one of ordinary skill in the art. In one example, the hardware components are implemented by one or more processing devices, or processors, or computers. A processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processing device, processor, or computer includes, or is connected to, one or more memories storing instructions or software that are executed by the processing device, processor, or computer and that may control the processing device, processor, or computer to implement one or more methods described herein. Hardware components implemented by a processing device, processor, or computer execute instructions or software, such as an operating system (OS) and one or more software applications that run on the OS, to perform the operations described herein with respect to FIGS. 1-5, for example. The hardware components also access, manipulate, process, create, and store data in response to execution of the instructions or software. For simplicity, the singular term “processing device”, “processor”, or “computer” may be used in the description of the examples described herein, but in other examples multiple processing devices, processors, or computers are used, or a processing device, processor, or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, remote processing environments, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described herein may be performed by a processing device, processor, or a computer as described above executing instructions or software to perform the operations described herein.

Instructions or software to control a processing device, processor, or computer to implement the hardware components and perform the methods as described above may be written as computer programs, code segments, instructions or any combination thereof, for individually or collectively instructing or configuring the processing device, processor, or computer to operate as a machine or special-purpose computer to perform the operations performed by the hardware components and the methods as described above. In one example, the instructions or software include machine code that is directly executed by the processing device, processor, or computer, such as machine code produced by a compiler. In another example, the instructions or software include higher-level code that is executed by the processing device, processor, or computer using an interpreter. Based on the disclosure herein, and after an understanding of the same, programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processing device, processor, or computer to implement the hardware components, such as discussed in any of FIGS. 1-4, and perform the methods as described above in any of FIGS. 1-5, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processing device, processor, or computer so that the processing device, processor, or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processing device, processor, or computer.

What is claimed is:

1. A wireless power transmission device, comprising:
a power transmitter configured to transmit power for charging;
a power receiver configured to perform a communication protocol with the power transmitter and receive the power transmitted from the power transmitter; and
an interface configured to exchange information for performing the charging based on the power receiver and the communication protocol and control power transmission from the power transmitter to the power receiver depending on the exchange of the information.

2. The wireless power transmission device of claim 1, wherein the information transmitted from the power receiver to the interface includes at least one of power receiver state information, charging related progress information, fault occurrence situation information, charging quantity display information, and charging remained time information.

3. The wireless power transmission device of claim 1, wherein the information transmitted from the interface to the power receiver includes at least one of terminal state information, charging start and finish information, charging time setting information, charging power setting information, and position correction start information and position correction finish information of a matching assistant.

4. The wireless power transmission device of claim 1, wherein the interface is a communication terminal wirelessly communicating with the power receiver.

5. The wireless power transmission device of claim 1, wherein the interface displays a wireless power transmission progress of a vehicle, displays a charging quantity, displays charging remained time, or displays no charging situation.

6. The wireless power transmission device of claim 1, wherein the interface receives at least one of charging start, charging stop, charging finish, charging power, and charging time.

7. The wireless power transmission device of claim 1, wherein the power transmitter includes a transmitting coil transmitting power and the power receiver includes a receiving coil receiving power transmitted from the transmitting coil.

8. The wireless power transmission device of claim 7, further comprising:
a matching assistant configured to drive the vehicle to match the transmitting coil with the receiving coil using position information of the transmitting coil and the receiving coil.

9. The wireless power transmission device of claim 8, wherein the information transmitted from the power receiver to the matching assistant includes at least one of state information of the power receiver, charging progress state information, vehicle position information, vehicle moving coordinate information, and vehicle moving check-in information.

10. The wireless power transmission device of claim 8, wherein the information transmitted from the matching assistant to the power receiver includes at least one of state information of the matching assistant, charging progress state information, vehicle position information, and vehicle moving progress state information.

11. The wireless power transmission device of claim 7, wherein the matching assistant is a Parking Assistant System (PAS).

12. The wireless power transmission device of claim 1, further comprising:
a Battery Management System (BMS) configured to be supplied with power from the power receiver to control the charging.

13. The wireless power transmission device of claim 1, wherein the interface provides a screen mode related to the charging.

14. A method for controlling a wireless power transmission device, comprising:
exchanging, by an interface, information for performing charging based on a power receiver and a communication protocol;
performing the communication protocol between a power transmitter and the power receiver depending on the exchange of the information;
transmitting, by the power transmitter, power depending on the communication protocol between the power transmitter and the power receiver; and
receiving, by the power receiver, the power from the power transmitter by a control of the interface.

15. The method of claim 14, further comprising:
driving the vehicle to match a transmitting coil with a receiving coil using a matching assistant depending on position information of the transmitting coil connected to the power transmitter and the receiving coil connected to the power receiver.

16. The method of claim 14, further comprising:
receiving, by a Battery Management System (BMS), the power from the power receiver to control the charging.
